(19) United States
(12) Patent Application Publication
(10) Pub. No.: US 2011/0032359 A1
(43) Pub. Date: Feb. 10, 2011

(54) SERVER DEVICE, MOBILE TERMINAL, ROAD JUNCTION GUIDANCE SYSTEM, AND ROAD JUNCTION GUIDANCE METHOD

(75) Inventor: Yuichi Tamura, Kawagoe (JP)

Correspondence Address: YOUNG & THOMPSON, 209 Madison Street, Suite 500, Alexandria, VA, 22314, US

(73) Assignee: PIONEER CORPORATION, Kawasaki-shi, Kanagawa (JP)

(21) Appl. No.: 12/988,591

(22) PCT Filed: Sep. 16, 2008
(86) PCT No.: PCT/JP2008/066628

§ 371 Date: Oct. 19, 2010

(51) Int. Cl. H04N 7/18

(52) U.S. Cl. 348/148; 348/E07.091

(57) ABSTRACT

In a server device, each time a photographed image and information related to time of photography are received from one of multiple mobile terminals, a generation processes for generating standard image information based on that image and information related to the time of photography. When generating this standard image information, the generation element generates the standard image information photographed when the moving body passes through that predetermined road junction to satisfy a predetermined speed variation condition. In a mobile terminal, an acquisition element acquires image information from the server device that designates any desired road junction, and, when the moving body passes through that predetermined road junction, a display control element refers to the manner in which the moving body passed through that road junction, and controls a display element to display an image on the basis of that image information. Storage resources are utilized efficiently, enhancing user convenience.

### TECHNICAL FIELD

The present invention relates to a server device, to a mobile terminal, to a road junction guidance system, and to a road junction guidance method.

### BACKGROUND ART

From the past, navigation devices mounted to moving bodies such as automobiles have been widespread. Moreover, the development in recent years of technology for navigation devices has been remarkable, and many functions are provided which aim at providing to the user guidance and instruction that are easier to understand.

Among such functions, a fundamental one is route guidance at road junctions. And, when providing route guidance at a junction, if it is possible to provide route guidance by using an actually photographed video clip of the junction, then this is much more easily understandable for the user than route guidance which uses texture mapping or the like but does not utilize an actually photographed video clip, and indeed may be said to be extremely realistic. Thus, in order to perform route guidance at road junctions by using actually photographed video clips, there has been proposed a navigation device that is built to have a camera function, and that utilizes video clips that have been actually photographed with that camera (refer to Patent Documents #1 and #2, hereinafter referred to as Prior Art Examples #1 and #2).

Here, with the technique of Prior Art Example #1, if several sets of frame data for which the photographic positions are the same are included in a video clip that has been obtained by photography, then the excess frame data is deleted, so as to leave only one set of frame data for the same photographic position. In this way guidance is performed with actually photographed video clips, while at the same time suppressing increase of the total amount of the data that is the foundation of the video clips to be presented during guidance. Furthermore, with the technique of Prior Art Example #2, video clips to be presented during guidance are created by converting still images that are photographed a predetermined distance apart into video of moving scenery.

Patent Document #1: Japanese Laid-Open Patent Publication 2002-269592;

Patent Document #2: Japanese Laid-Open Patent Publication 2004-212232.

### DISCLOSURE OF THE INVENTION

### Problems to be Solved by the Invention

Now, when a vehicle enters a road junction and leaves the junction, and in particular, when making a right turn or a left turn, it decelerates and accelerates. Due to this, it is desirable to perform route guidance by using an actually photographed video clip that matches the way in which the speed changes while the vehicle passes through the actual junction.

However, with the technique of Prior Art Example #1 described above, the progression of frames in the video clip for guidance comes to differ from the progression of frames in the video clip while passing through the actual road junction. Since, due to this, the frame data that corresponds to the vehicle position comes to be replay displayed each time the vehicle position is detected, accordingly, in the final analysis, these images for guidance are no better than video clips in which still image frames are displayed in succession. As a result it is difficult to provide road junction guidance which is very realistic, irrespective of the fact that actually photographed video clips are being used. Moreover, with the technique of Prior Art Example #2 described above, since the video clips to be presented are created during guidance on the basis of still images at predetermined intervals apart, accordingly, in a similar manner to the case of the technique of Prior Art Example #1, these images for guidance are no better than video clips in which still image frames are displayed in succession, so that it is difficult to say that the road junction guidance that is provided is very realistic.

Due to this, a technique has been eagerly anticipated that can perform route guidance brimming over with reality while performing route guidance at road junctions. Responding to this requirement is considered as being one problem to be solved by the present invention.

The present invention has been conceived in consideration of the circumstances described above, and its object is to provide a novel road junction guidance system and road junction guidance method, which, along with utilizing storage resources with good efficiency, can also enhance the convenience for the user.

### Means for Solving the Problems

Considered from a first standpoint, the present invention is a server device that can communicate with at least one mobile terminal, characterized by comprising: a collection means that collects a photographic image and information related to the time of photography thereof, reported from a mobile terminal that receives a request for photography when passing through at least one predetermined road junction; a generation means that, on the basis of the results of collection by said collection means, generates standard image information photographed while passing through said predetermined road junction with a predetermined speed variation condition being satisfied; a storage means that stores said standard image information; and a standard image reporting means that, upon receipt of an acquisition request for an image for a passage through one of said predetermined road junction, reports image information corresponding, in said standard image information, to said acquisition request, to the mobile terminal that issued said acquisition request.

Considered from a second standpoint, the present invention is a mobile terminal that moves along with a moving body unit and that can communicate with a server device according to any one of Claims 1 through 5, characterized by comprising: a display means that displays an image; an acquisition means that makes an acquisition request to said server device, and acquires from said server device image information when passing through a road junction, corresponding to said acquisition request; and a display control means that performs control of display upon said display means of an image based upon the result of acquisition by said acquisition means.

Moreover, considered from a third standpoint, the present invention is a road junction guidance system, characterized by comprising a server device according to any one of Claims 1 through 5; and at least one mobile terminal that can communicate with said server device, and in that said mobile terminal comprises: a display means that displays an image; an acquisition means that makes an acquisition request to said server device, and acquires from said server device image information when passing through a road junction, corresponding to said acquisition request; and a display control means that performs control of display upon said display means of an image based upon the result of acquisition by said acquisition means.

Furthermore, considered from a fourth standpoint, the present invention is a road junction guidance method performed in cooperation by at least one mobile terminal and a server device that can communicate with said mobile terminal, characterized by comprising: a collection process in which said server device collects a photographic image and information related to the time of photography thereof, reported from a mobile terminal that receives a request for photography when passing through at least one predetermined road junction; a generation process in which, on the basis of the results of collection by said collection process, said server device generates standard image information photographed while passing through said predetermined road junction with a predetermined speed variation condition being satisfied; a standard image reporting process in which said server device, upon receipt of an acquisition request for an image for a passage through one of said predetermined road junction, reports an image corresponding, in said standard image information, to said acquisition request, to the mobile terminal that issued said acquisition request; and a display process in which the mobile terminal that issued said acquisition request performs display on the basis of an image information that corresponds to said acquisition request.

### BRIEF DESCRIPTION OF THE DRAWINGS

FIG. 1 is a block diagram for explanation of the structure of a road junction guidance system according to an embodiment of the present invention;

FIG. 2 is a block diagram for explanation of the structure of a road junction guidance system according to the first example of the present invention;

FIG. 3 is a block diagram for explanation of the structure of a server device of FIG. 2;

FIG. 4 is a figure for explanation of the structure of standard image information (SIA) of FIG. 3;

FIG. 5 is a figure for explanation of an example of a predetermined road junction;

FIG. 6 is a figure for explanation of the contents of individual standard image information (CSAⱼ) of FIG. 4;

FIG. 7A is a figure for explanation of an example of a predetermined speed variation condition, for the first example (part 1 thereof);

FIG. 7B is a figure for explanation of an example of this predetermined speed variation condition, for the first example (part 2 thereof);

FIG. 8 is a block diagram for explanation of the structure of a navigation device of FIG. 2;

FIG. 9 is a sequence diagram for explanation of processing for generating the standard image information (SIA) in the first example;

FIG. 10 is a flow chart for explanation of standard image generation processing of FIG. 9;

FIG. 11 is a figure for explanation of the structure of a road junction guidance system according to the second example of the present invention;

FIG. 12 is a figure for explanation of the structure of a server device of FIG. 11;

FIG. 13 is a figure for explanation of the contents of individual standard image information (CSB) in the second example;

FIG. 14 is a figure for explanation of an example of a positional condition that is derived from a predetermined speed variation condition, in the second example;

FIG. 15 is a figure for explanation of the contents of photographic image information (IMB) of FIG. 13;

FIG. 16 is a sequence diagram for explanation of processing for generating the standard image information (SIB) in the second example;

FIG. 17 is a flow chart for explanation of standard image generation processing of FIG. 16; and

FIG. 18 is a figure for explanation of a photographic position that satisfies a positional condition, and of a permitted range for this photographic position.

### BEST MODE FOR CARRYING OUT THE INVENTION

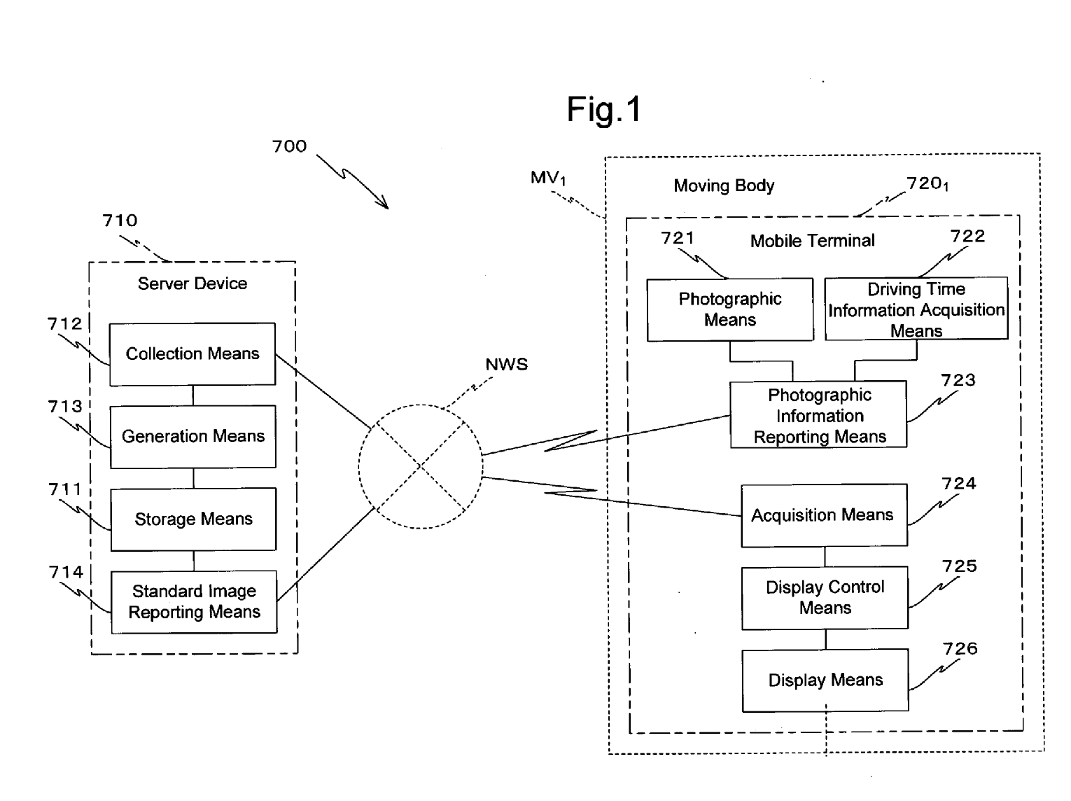

An embodiment of the present invention will now be explained below with reference to FIG. 1. It should be understood that, in the following explanation, the same reference symbols are appended to elements that are the same or equivalent, and duplicated explanation is omitted.

### [Structure]

In FIG. 1, there is shown the schematic structure of a road junction guidance system 700 according to the embodiment.

As shown in this FIG. 1, this road junction guidance system 700 comprises a server device 710 and mobile terminals 720ₚ (where p=1, 2, . . . ). Here, the server device 710 is disposed in a fixed location. Moreover, the mobile terminals 720ₚ are mounted upon moving bodies MVₚ, and thus shift along with these moving bodies MVₚ. And the server device 710 and the mobile terminals 720ₚ are adapted to be capable of performing mutual data communication via a network system NWS. It should be understood that the exchange of detailed information between these devices will be described hereinafter. Here, the exchange of information between these devices is explained as being performed via the network system NWS.

### <Structure of the Server Device 710>

The server device 710 described above comprises a storage means 711, a collection means 712, a generation means 713, and a standard image reporting means 714.

The storage means 711 described above stores standard image information for predetermined road junctions. Here, “standard image information” is image information about the predetermined road junctions photographed by the mobile terminals 720ₚ when the moving bodies MVₚ pass through these predetermined junctions while satisfying predetermined speed variation conditions. And, for each of the predetermined road junctions, photographic images when passing through that predetermined junction are classified in this standard image information according to at least one of certain environmental factors at the time of photography including the photographic date and time and the weather at the time of photography, and are stored in the storage means 711. Moreover, this standard image information also includes a predetermined speed variation condition for each of the predetermined road junctions. It should be understood that the information stored in this storage means 711 is not limited to only being the standard image information; various types of information may be stored therein.

When one of the mobile terminals 720ₚ passes through one of the predetermined road junctions, the collection means 712 described above sends a request for photography to that mobile terminal. Here, in this “request for photography”, a ground point for the start of photography of that predetermined road junction and a ground point for the end of photography thereof are designated.

When sending a request for photography to the mobile terminal 720ₚ, if for example the normal range of travel of the moving body MVₚ is known, then the collection means 712 is able to send a request for photography when the mobile body passes through any desired road junction in that travel range. Furthermore, when a planned travel route has been reported from the mobile terminal 720ₚ, then the collection means 712 is able to send to the mobile terminal 720ₚ that has reported that travel route a request to perform photography when passing through any desired road junction upon that planned travel route. Moreover, if position information for the moving body MVₚ is periodically being received from its mobile terminal 720ₚ, then the collection means 712 is able to send a request to perform photography when passing through any desired junction among those road junctions which, it is estimated from the change of this position information, the mobile terminal 720ₚ will pass through, to that mobile terminal 720ₚ which it is estimated will pass through that junction.

When a photographic image and information related to the time of photography are reported from the mobile terminal 720ₚ that has received a request for photography, then the collection means 712 collects that photographic image and its information related to the time of photography. The result of collection by the collection means 712 is sent to the generation means 713. Here, in the “information related to the time of photography”, it may be arranged to include information about environmental factors such as travelling information for the moving body MVₚ when the moving body MVₚ passes through the predetermined road junction and the weather at the time of photography and so on.

On the basis of the photographic image and the information related to the time of photography that are the result of collection by the collection means 712, the generation means 713 described above generates standard image information photographed when the moving body MVₚ passed through the predetermined road junction while satisfying a predetermined speed variation condition. For the generation of this kind of standard image information, for the speed change of the moving body MVₚ when it passes through the predetermined junction, it may be arranged to use the result of continuous photography when the predetermined speed variation condition has been satisfied, just as it is.

Furthermore, in the generation of the standard image information, it may be arranged to use the result of photography at a photographic position that satisfies a positional condition which is derived from the predetermined speed variation condition. Here this positional condition may, for example, be established as being that, under the predetermined speed variation condition, at predetermined time intervals, the moving body MVₚ is in approximately the same positions as its positions when it passed through the predetermined road junction.

During generation of the standard image information, when referring to the actual speed change of the moving body MVₚ when it passes through the predetermined road junction, there is included, in the travelling information in the information related to the time of photography, speed change information for when the moving body MVₚ, which is moving along with the mobile terminal 720ₚ that receives the request for photography, passes through the predetermined junction. The generation means 713 generates the standard image information when this speed change information that is included in the information related to the time of photography satisfies the predetermined speed variation condition.

Furthermore, during the generation of the standard image information, when referring to the actual photographic position, there is included, in the travelling information in the information related to the time of photography, photographic position information for each image frame in the photographic image (photographed video clip). When generating the standard image information, the generation means 713 employs the image frames of the photographic image for which the photographic position information included in the information related to the time of photography satisfies the positional condition.

When passing through the predetermined junction, the standard image reporting means 714 described above receives an image acquisition request from the mobile terminal 720ₚ. Upon receipt of this acquisition request, the standard image reporting means 714 reads out from the storage means 711 image information when passing through the predetermined junction that corresponds to that acquisition request. The standard image reporting means 714 reports the result that it has read out to the mobile terminal 720ₚ that issued that acquisition request. It should be understood that, as described hereinafter, it may also be arranged for information about at least one environmental factor at the time of photography, such as the date and time of photography and the weather at the time of photography, to be included in this acquisition request, in addition to a designation of the predetermined road junction.

<Structure of the Mobile Terminals 720ₚ>

One of the mobile terminals 720ₚ described above (where p=1, 2, . . . ) comprises a photographic means 721, a driving time information acquisition means 722, and a photographic information reporting means 723. Moreover, the mobile terminal 720ₚ comprises an acquisition means 724, a display control means 725, and a display means 726.

The photographic means 721 described above photographs the surroundings of the moving body MVₚ based upon control by the photographic information reporting means 723. And the results of photography by the photographic means 721 are sent to the photographic information reporting means 723.

The driving time information acquisition means 722 described above acquires driving time information for the moving body MVₚ based upon control by the photographic information reporting means 723. Here “driving time information” is arranged to be determined in advance so that, during the generation of the above described standard image information, when referring to the actual change of speed, it becomes information related to the speed of the moving body MVₚ. Furthermore, during the generation of the standard image information, when referring to the actual photographic position, “driving time information” is arranged to be determined in advance so that it becomes information related to the position of the moving body MVₚ. It should be understood that it may be arranged for information about at least one environmental factor at the time of photography, such as the date and time of photography and the weather at the time of photography, to be included in this travelling information. The result of acquisition by the driving time information acquisition means 722 is sent to the photographic information reporting means 723.

The photographic information reporting means 723 described above receives requests for photography from the server device 710 when passing through predetermined road junctions. Upon receipt of such a request for photography, the photographic information reporting means 723 issues a command to the photographic means 721 for photography between the photography start ground point and the photography end ground point specified by that request for photography, and also receives results of acquisition by the driving time information acquisition means 722. And the photographic information reporting means 723 acquires the results of photography by the photographic means 721 for the passage through the predetermined road junction for which the request for photography was received, and also generates information related to the time of photography for when passing through the predetermined junction on the basis of the result of the above acquisition by the driving time information acquisition means 722. Next, at a predetermined timing, the photographic information reporting means 723 reports the photographic image that is the result of the above photography and the information related to the time of photography to the server device 710.

The acquisition means 724 described above sends acquisition requests to the server device 710 for image information when passing through road junctions. As a response to this request, the acquisition means 724 acquires from the server device 710 image information when passing through the junction that corresponds to that acquisition request. It should be understood that, in addition to the predetermined road junction designated in this acquisition request, when the server device 710 is able to respond, it may also ensure that information is included about at least one environmental factor at the time of photography, such as the date and time of photography and the weather at the time of photography.

The display control means 725 described above performs control of the image display means 726 on the basis of the results of acquisition by the acquisition means 724. During this control of the display means 726, while the moving body MVₚ passes through the predetermined road junction, it may also be arranged for the display control means 725 to refer to the way in which the moving body MVₚ passes through the junction, and to perform control of the image display means 726 on the basis of the result of acquisition by the acquisition means 724. Here “the way in which it passes through the junction” refers to differences in the mode of passing through the junction, such as a speed that is faster than the speed in a mode which would satisfy the predetermined speed variation condition, or that is slower, or the like.

The display means 726 described above displays images on the basis of acquisition by the acquisition means 724, under the control of the display control means 725.

### [Operation]

The road junction guidance method executed by the road junction guidance system 700 having the structure described above will now be explained.

### <Processing for Generation of the Standard Image Information>

First, the processing by the road junction guidance system 700 for generating the standard image information will be explained. It should be understood that it will be supposed that the collection means 712 of the server device 710 sends requests for photography to the mobile terminals 720ₚ (where p=1, 2, . . . ) when they pass through predetermined junctions.

In a mobile terminal 720ₚ that has received a request for photography from the server device 710, the photographic information reporting means 723 controls the photographic means 721 and the driving time information acquisition means 722. The photographic information reporting means 723 sends to the server device 710 a photographic image that is the result of photography by the photographic means 721 from the start ground point for photography designated by the request for photography to the end ground point for photography, and information related to the time of photography that has been generated on the basis of the result of acquisition by the driving time information acquisition means 722.

Upon receipt by the server device 710 of a photographic image and information related to the time of photography from any one of the mobile terminals 720ₚ (where p=1, 2, . . . ), the collection means 712 collects this photographic image and this information related to the time of photography, and sends them to the generation means 713. Upon receipt of this photographic image and this information related to the time of photography, if it was photographed while the passage through the predetermined road junction satisfied a predetermined speed variation condition, then the generation means 713 generates standard image information.

During this processing for generation of standard image information, when referring to the actual change of speed, the generation means 713 decides whether or not, among the standard image information that is recorded in the storage means 711, there exists any photographic image of this predetermined road junction for which the environmental factors at the time of photography are the same. If no such photographic image of this predetermined junction exists, then the generation means 713 generates standard image information upon the basis of the photographic image and the information related to the time of photography that are the result of collection. On the other hand, if a photographic image of this predetermined road junction does exist, then the generation means 713 compares together the information related to the time of photography for the photographic image that has been read in, and the information related to the time of photography that has been newly collected. When the result of this comparison is that the newly collected information related to the time of photography is closer to the predetermined speed variation condition, then the generation means 713 updates the standard image information; while, if it is the information related to the time of photography that has been read in that is closer to the predetermined speed variation condition, then it does not perform updating of the standard image information.

Furthermore, when referring to the actual photographic position during the generation of the standard image information, the generation means 713 decides, for each image frame of the photographic image that has been collected, whether or not the photographic position of that image frame satisfies a positional condition. Next, if the photographic position of that image frame satisfies that positional condition, then the generation means 713 decides whether or not, among the standard image information stored in the storage means 711, any image frame exists for which the photographic position is the same and moreover the environmental factors at the time of photography are the same. If no such image frame that is the same exists, then the generation means 711 employs this image frame of the photographic image that has been collected as a part of the standard image information. On the other hand, if such an image frame that is the same does exist, then, if this image frame of the photographic image that has been collected has been used as standard image information, the generation means 713 decides whether or not it is a continuous smooth image, and if it has decided that it is a continuous smooth image, then it performs updating by using this image frame of the photographic image that has been collected as a part of the standard image information.

Here, by a “continuous smooth image” is meant an image for which, when an image frame of the photographic image that has been collected is employed as standard image information, and when replayed as a standard image, the movement of elements in the entire frame does not greatly change (for example, deviation of the position of a building in the image, or the like).

Subsequently, each time that a new photographic image and information related to the time of photography are received from any one of the mobile terminals 720ₚ (where p=1, 2, . . . ), generation processing for standard image information is performed in a similar manner to that described above.

### <Road Junction Guidance Processing>

Next, the guidance processing performed by this road junction guidance system 700 at a predetermined junction will be explained.

When approaching a predetermined road junction for which guidance according to an actually photographed video clip should be received, then the acquisition means 724 of the mobile terminal 720ₚ sends to the server device 710 an acquisition request for image information when passing through that junction. Here it may be arranged for “a junction for which guidance according to an actually photographed video clip should be received” to be specified in advance by the user.

Upon receipt of this acquisition request from the mobile terminal 720ₚ, in the server device 710, the standard image reporting means 714 reads in from the storage means 711 image information for when passing through the predetermined road junction that corresponds to that acquisition request. The standard image reporting means 714 sends the result of this reading to the mobile terminal 720ₚ that issued the acquisition request.

As a response to an acquisition request that has been transmitted, the acquisition means 724 of the mobile terminal 720ₚ acquires a photographic image when passing through the predetermined road junction. Next, the display control means 725 performs control of the image display means 726 on the basis of the result of acquisition by the acquisition means 724. It would also be acceptable for it to be arranged for the display control means 725, during this control, to perform control of the image display means 726 on the basis of the result of acquisition by the acquisition means 724, while referring to the way in which the moving body MVₚ passed through the junction.

As has been explained above, according to the embodiment of the present invention, it is possible to enhance the convenience to the user during route guidance at road junctions.

It should be understood that, as the moving body in the embodiment described above, for example, a vehicle or the like may be suggested. And, as the mobile terminal, if the moving body is a vehicle, then a car navigation device or the like may be suggested.

Furthermore, it would also be possible for the road junction guidance system 700 of the above embodiment to include two or more computers that serve as calculation means, and for the functions of the various means described above, with the exception of the storage means 711, the photographic means 721, and the display means 726, to be implemented by the execution of programs. It could be arranged for these programs to be acquired in a format in which they are recorded upon a transportable recording medium such as a CD-ROM or a DVD or the like; or they could also be acquired in a format in which they are transmitted via a network such as the internet or the like.

### EXAMPLES

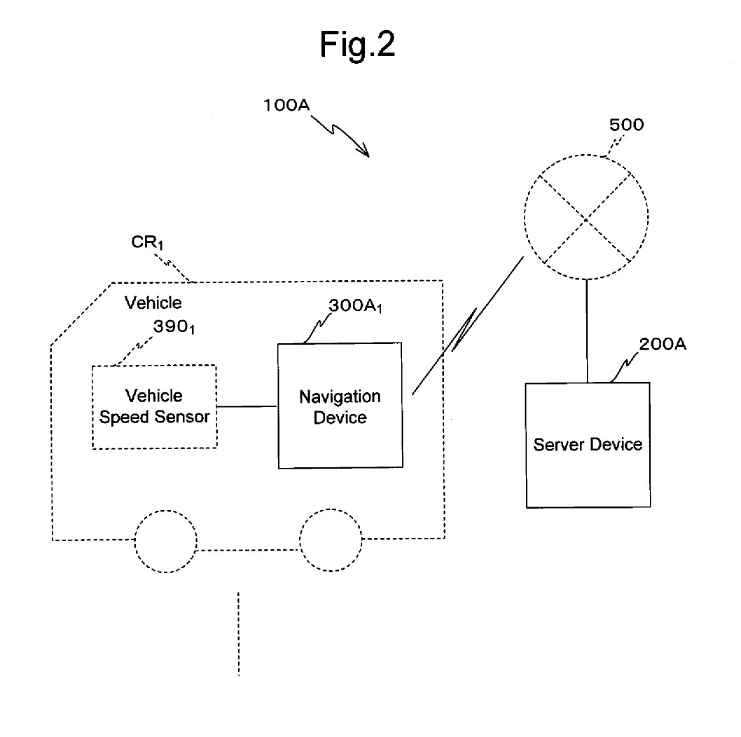

Examples of the present invention will now be explained with reference to FIGS. 2 through 18. It should be understood that, in the following explanation and in the drawings, the same reference symbols are appended to elements that are the same or equivalent, and duplicated explanation is omitted.

### The First Example

First, the first example of the present invention will be explained with particular reference to FIGS. 2 through 10.

FIG. 2 shows the schematic structure of a road junction guidance system 100A according to the first example. It should be understood that this road junction guidance system 100A is one aspect of the road junction guidance system 700 of the embodiment described above (refer to FIG. 1).

### <Structure>

As shown in FIG. 2, this road junction guidance system 100A comprises a server device 200A that plays the role of the server device 710, and navigation devices 300Aₚ that play the roles of the mobile terminals 720ₚ (where p=1, 2, . . . ).

Here, the server device 200A, for example, may be disposed in a fixed position within a predetermined building. Moreover, the navigation devices 300Aₚ may be mounted in vehicles CRₚ that play the roles of the moving bodies MVₚ, and thus are adapted to shift along with the vehicles CRₚ.

The server device 200A described above is capable of communicating with the navigation devices 300Aₚ via a network system 500. The details of the data transferred between the server device 200A and the navigation devices 300Aₚ will be described hereinafter.

A vehicle speed sensor 390ₚ is mounted to the vehicle CRₚ, and is connected to the navigation device 300Aₚ described above. Moreover, the navigation device 300Aₚ is adapted to perform data communication with the server device 200A, via the network system 500. The details of the data which the navigation device 300Aₚ transfers between the vehicle speed sensor 390ₚ and the server device 200A will be described hereinafter.

### <<Structure of the Server Device 200A>>

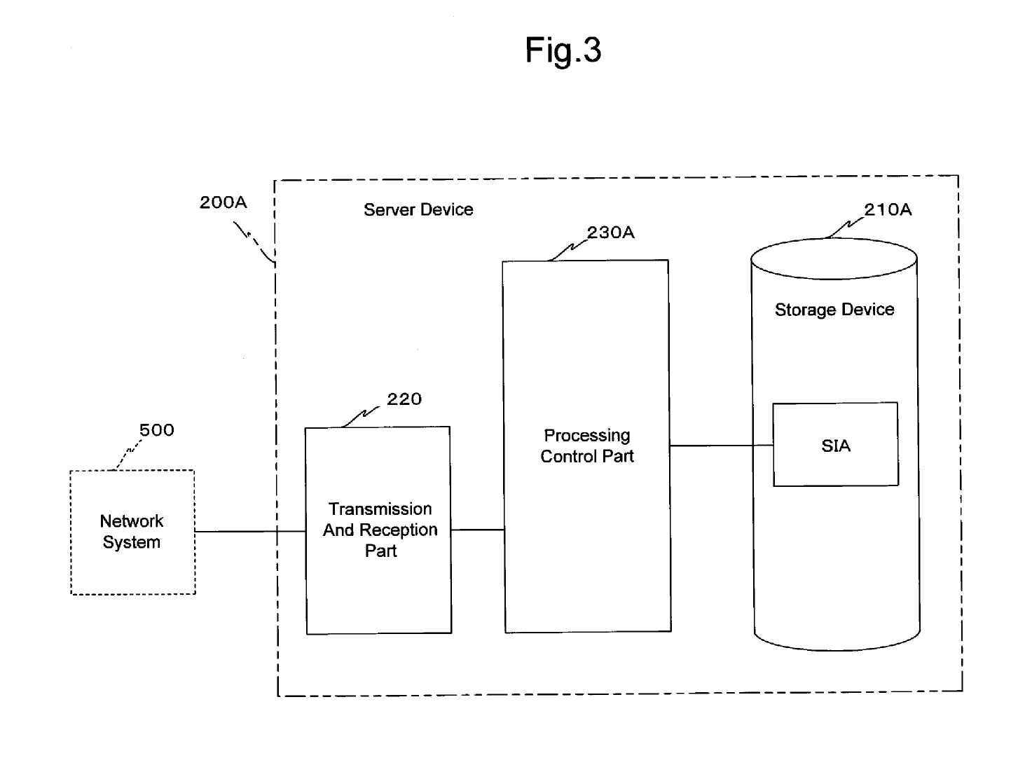

The server device 200A described above is endowed with a function of generating the standard image information, and with a function of reporting a photographic image in the standard image information. As shown in FIG. 3, this server device 200A having these functions comprises a storage device 210A that plays the role of the storage means 711, a transmission and reception part 220, and a processing control part 230A.

The storage device 210A described above consists of a non-volatile storage device such as a hard disk device or the like. This storage device 210A stores data of various types, such as standard image information (SIA) and the like. The processing control part 230A is adapted to be capable of accessing this storage device 210A.

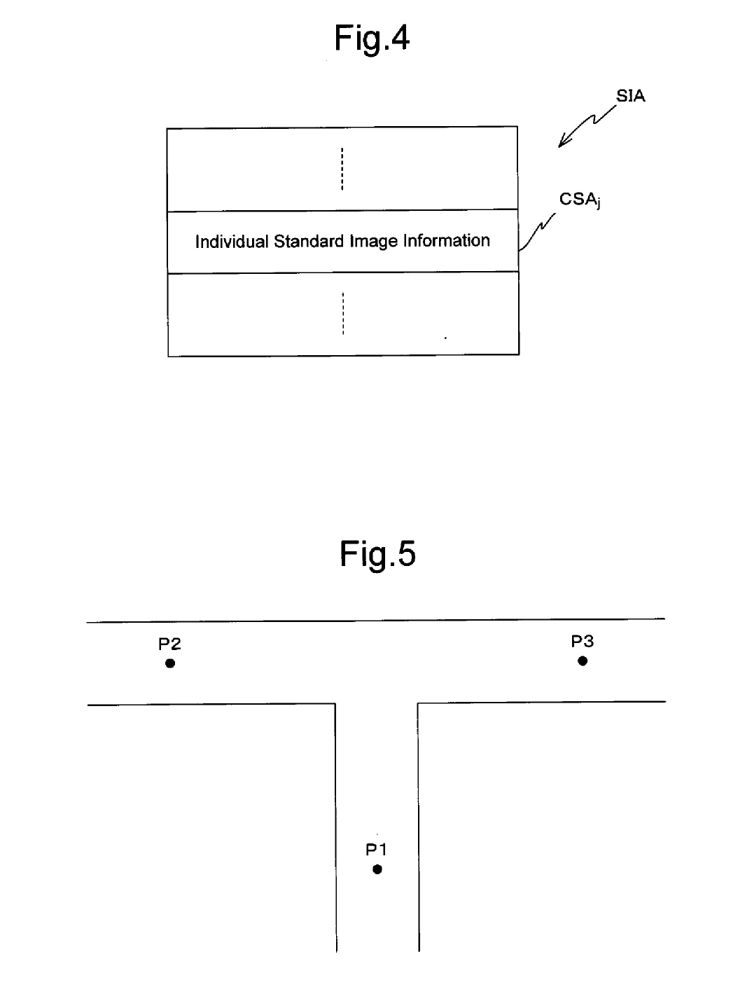

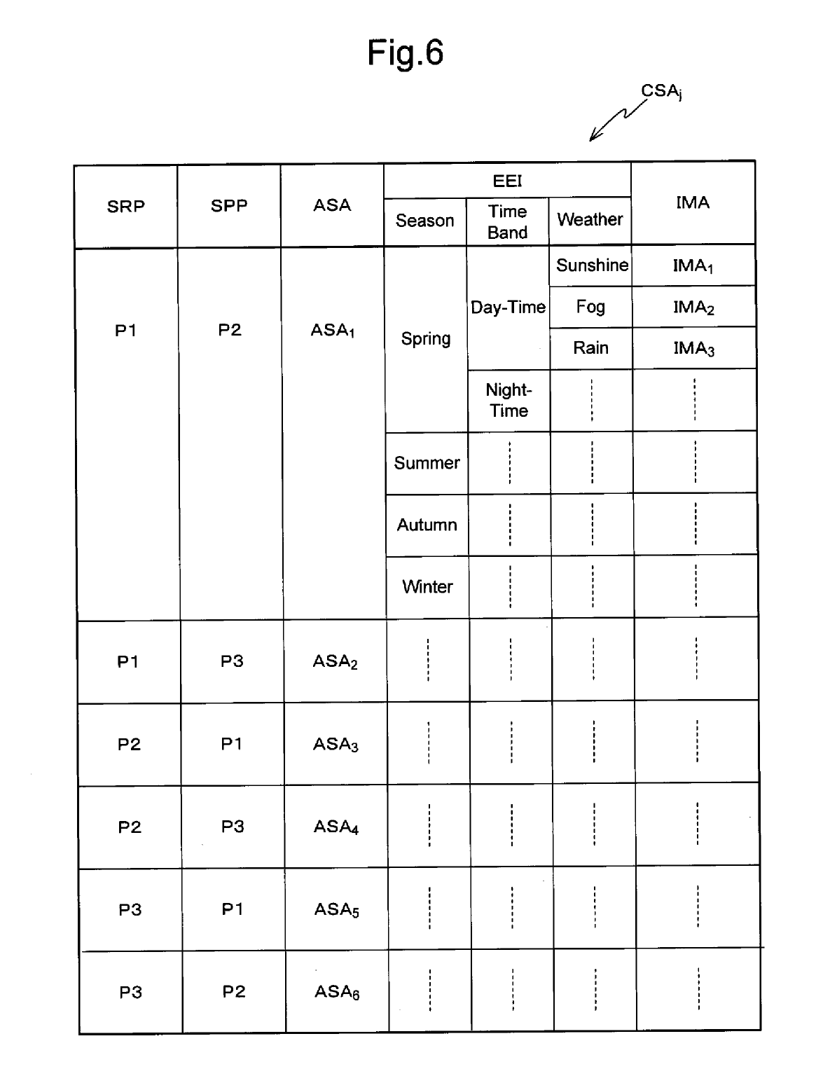

Individual standard image information CSAⱼ (where j=1, 2, . . . ) for each one of the predetermined road junctions is registered in the standard image information (SIA) described above, as shown in FIG. 4. Now, the individual standard image information CSAⱼ for a predetermined letter-“T” type road junction as shown in FIG. 5 will be explained. As shown in FIG. 6, for each route pattern at the predetermined road junction such as a right turn, a left turn, and so on, the individual standard image information CSAⱼ contains a photography start ground point (SRP), a photography end ground point (SPP), a speed variation condition (ASA), and photographic image information (IMA) classified by information about environmental factors at the time of photography (EEI).

Here, there are six route patterns for the predetermined road junction, since the road junction shown in FIG. 5 is a letter-“T” type road junction. Moreover, the information about environmental factors at the time of photography is “season”, “time band”, and “weather”. It should be understood that, in this first example, “season” is classified into “spring”, “summer”, “autumn”, and “winter”, and “time band” is classified into “day-time” and “night-time”. Moreover, “weather” is classified into “sunshine”, “fog”, and “rain”.

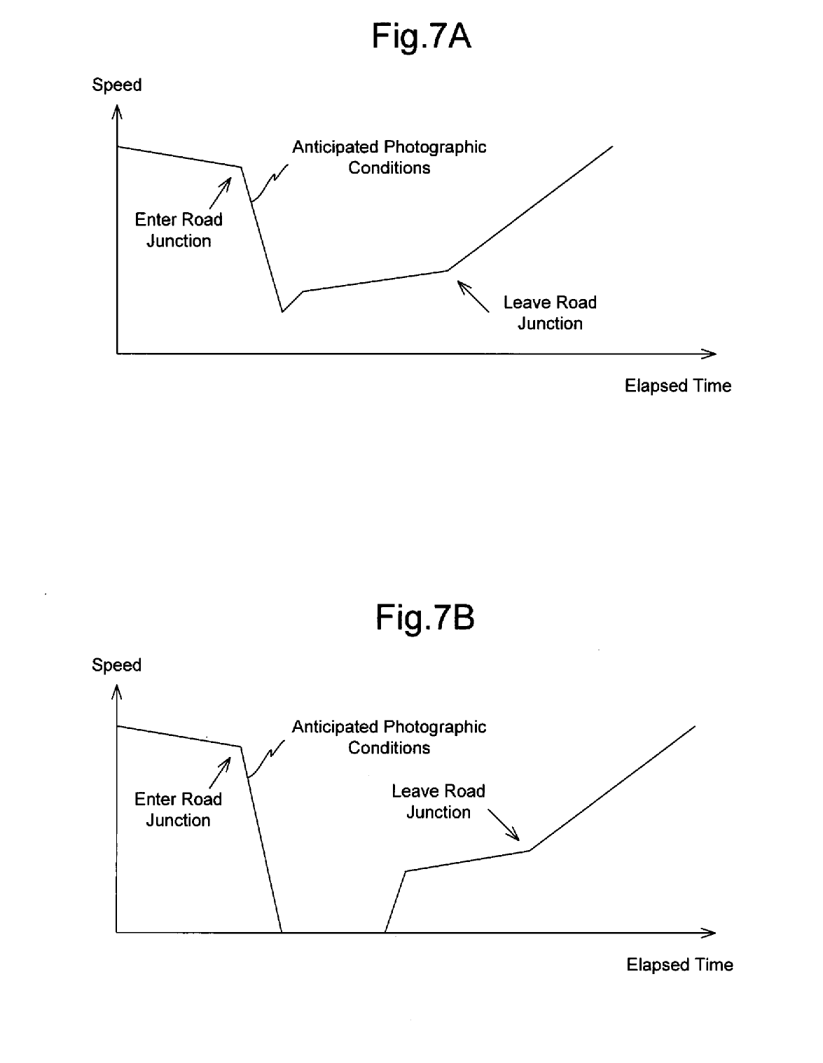

Moreover, in this first example, the speed variation condition (ASA) is a condition related to change of the speed of the vehicle CRₚ during its passage through the predetermined road junction. In FIG. 7A, for the road junction shown in FIG. 5, an example is shown of anticipated changes of the speed of the vehicle CRₚ at this road junction while it travels from the point P1 to the point P2, thus executing a left turn. Furthermore, in FIG. 7B, for the same road junction, an example is shown of anticipated changes of the speed of the vehicle CRₚ at this road junction while it travels from the point P1 to the point P3, thus executing a right turn. In this manner, the speed variation condition is different according to the direction of progression of the vehicle CRₚ, i.e. according as to whether it is making a left turn or a right turn or the like.

It should be understood that the speed variation condition described above is determined in advance by experiment, simulation, experience, and so on.

Moreover, in this first example, the photographic image that is the result of photography and speed change information for the vehicle CRₚ during acquisition of this photographic image are also included in the photographic image information (IMA).

Returning to FIG. 3, the transmission and reception part 220 described above performs control of communication with the network system 500. This transmission and reception part 220 sends data received from the network system 500 to the processing control part 230A. Moreover, the transmission and reception part 220 sends data received from the processing control part 230A to the network system 500. By utilizing the transmission and reception part 220, the server device 200A (in more detail, the processing control part 230A) is enabled to perform communication with the navigation device 300Aₚ.

The processing control part 230A described above performs overall control of the entire server device 200A. This processing control part 230A comprises a central processing device (CPU) and circuitry peripheral thereto. It is arranged for the various types of function described above to be implemented by the processing control part 230A executing programs of various kinds. Among these functions, there are included the functions of the collection means 712, of the generation means 713, and of the standard image reporting means 714 of the embodiment described above.

In this first example, it is arranged for this processing control part 230A, via the transmission and reception part 220, to receive planned travel routes from the navigation devices 300Aₚ and to transmit requests for photography to the navigation devices 300Aₚ. In more detail, in this first example, when a planned travel route is received from some one of the navigation devices 300Aₚ, a search is made as to whether or not some predetermined road junction is present upon this planned travel route for which a photographic image ought to be registered in the storage device 210A. And, if some such predetermined road junction is present upon that planned travel route, then the processing control part 230A transmits a request for photography when passing through this predetermined road junction to the navigation device 300Aₚ that reported this travel route.

Moreover, when the processing part 230A collects via the transmission and reception part 220 a photographic image and information related to the time of photography from a navigation device 300Aₚ that receives a request for photography, then it refers to the actual speed change information, and generates standard image information that was photographed when the vehicle CRₚ passed through the predetermined road junction in a way which satisfies the speed variation condition. It should be understood that, in this first example, as will be described hereinafter, speed change information for the vehicle CRₚ and the environmental factor information for “season”, “time band” and “weather” are included in this information related to the time of photography.

While generating this standard image information, the processing control part 230A accesses the storage device 210A, and decides whether or not, among the individual standard image information for the predetermined road junction corresponding to the photographic image that has been collected, there exists some photographic image for which the route pattern such as straight ahead, right turn, or left turn is the same, and moreover for which the environmental factors of “season”, “time”, and “weather” are the same. And, if no such photographic image exists, then the processing control part 230A creates individual standard information for that predetermined road junction, on the basis of the photographic image and the information related to the time of photography that has been collected.

On the other hand, if such a photographic image does exist, then the processing control part 230A compares together the speed change information for when this photographic image registered in the individual standard information was acquired, and the speed change information acquired from the navigation device 300Aₚ, and decides which one of them is closer to the speed variation condition. When it is the speed change information acquired from the navigation device 300Aₚ that is the closer to the speed variation condition, then the processing control part 230A updates the contents of the individual standard image information; but, when it is the speed change information registered in the individual standard image information that is the closer to the speed variation condition, then the processing control part 230A does not perform such updating of the standard image information.

It should be understood that the algorithm that is utilized for deciding the closeness of the actual speed change information to the speed variation condition by the processing control part 230A is determined in advance on the basis of experiment, simulation, experience, and so on.

Furthermore, via the transmission and reception part 220, the processing control part 230A receives from the navigation devices 300Aₚ requests for acquisition of images when passing through predetermined road junctions. Upon receipt of such an acquisition request, the processing control part 230A accesses the storage device 210A, and reads out photographic image information for when passing through the predetermined road junction that corresponds to that acquisition request. The processing control part 230A sends this photographic image information to the navigation device 300Aₚ that issued the acquisition request.

It should be understood that, in this first example, in the acquisition request, in addition to a specification of the desired road junction, there is also included the environmental factors of “season”, “time band”, and “weather”.

### <<Structure of the Navigation Devices 300Aₚ>>

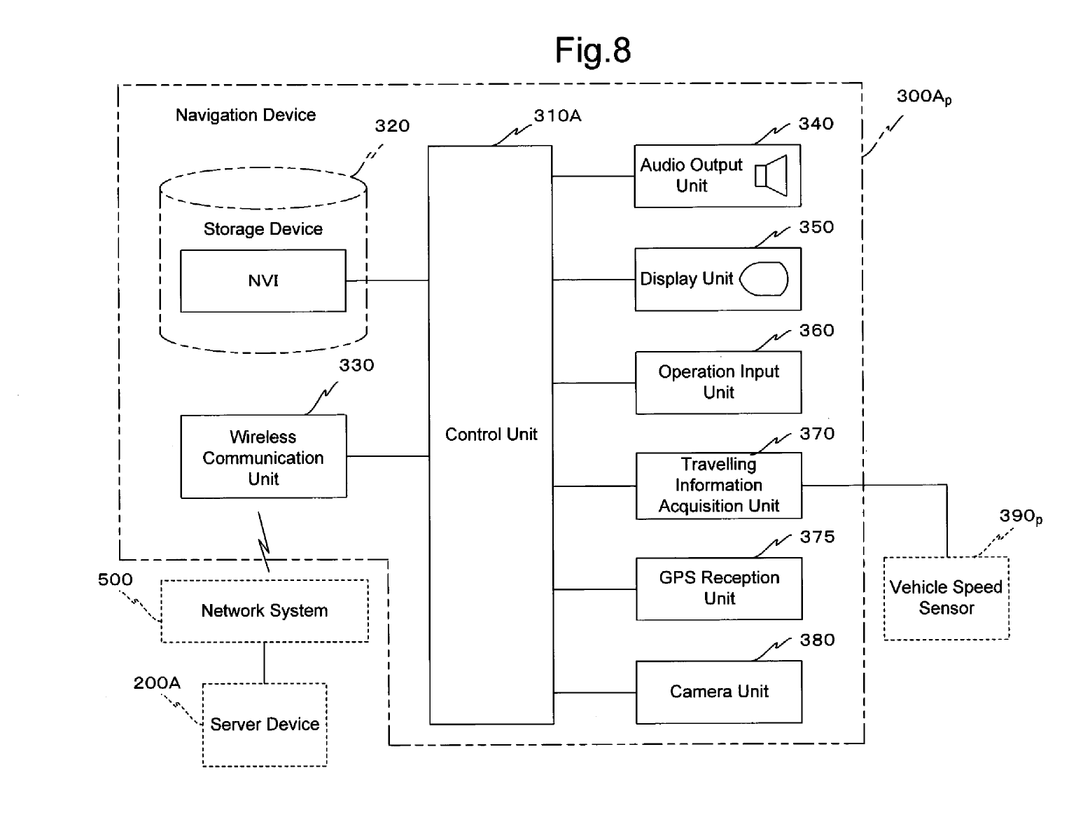

The navigation devices 300Aₚ described above (where p=1, 2, . . . ) are endowed with a function of photographing surrounding images, a function of acquiring driving time information, a function of reporting these surrounding images and this driving time information, a function of acquiring photographic image information, and a function of controlling photographic image display. As shown in FIG. 8, one of these navigation devices 300Aₚ that has these functions comprises a control unit 310A, a storage device 320, and a wireless communication unit 330 that serves as one portion of the driving time information acquisition means 722. Furthermore, the navigation device 300Aₚ comprises an audio output unit 340, a display unit 350 that serves as the display means 726, and an operation input unit 360. Moreover, the navigation device 300Aₚ comprises a traveling information acquisition unit 370 that serves as one portion of the driving time information acquisition means 722, a GPS (Global Positioning System) reception unit 375 that serves as one portion of the driving time information acquisition means 722, and a camera unit 380 that serves as the photographic means 721.

The control unit 310A described above controls the navigation device 300Aₚ as a whole. This control unit 310a will be described hereinafter.

The storage device 320 described above is a non-volatile storage device, and consists of a hard disk device or the like. This storage device 320 stores data of various kinds, such as information for navigation (NVI) and so on. The control unit 310A is adapted so as to be capable of accessing this storage device 320.

Data of various types utilized for navigation is stored in the information for navigation described above, such as map data, POI (Point Of Interest) data, background data, and so on. These various types of data are read in by the control unit 310A.

The wireless communication unit 330 described above comprises an antenna not shown in the figures and so on. This wireless communication unit 330 processes signals received by that antenna that have been prepared by the network system 500 and received from a base station, and converts them into digital data signals that can be processed by the control unit 310A. Furthermore, the wireless communication unit 330 processes signals transmitted from the control unit 310A, and sends them via the above antenna to the network system 500 (more exactly, to the base station) in the form of wireless signals.

By utilizing this wireless communication unit 330, it is arranged for the navigation device 300Aₚ (more exactly, the control unit 310A) to be adapted to be able to perform communication with the server device 200A.

Furthermore, it is possible to acquire weather information at a desired date and time and at a designated position by sending an acquisition request for weather information in which the position is specified to a weather information server not shown in the figures using this wireless communication unit 330. The weather information that has been acquired in this manner is sent to the control unit 310A.

The audio output unit 340 described above comprises a speaker, and outputs audio corresponding to audio data received from the control unit 310A. On the basis of control by the control unit 310A, this audio output unit 340 outputs guidance audio related to navigation processing, such as the direction of travel for the vehicle CRₚ, the travel situation, the traffic situation, and so on.

The display unit 350 described above comprises a display device such as a liquid crystal panel or the like, and displays images corresponding to display data received from the control unit 310A. And, on the basis of control by the control unit 310A, during navigation processing, this display unit 350 displays images such as video clips actually photographed when passing through predetermined road junctions, map information, route information, and guidance information.

The operation input unit 360 described above comprises a key unit provided to the main body portion of the navigation device 300Aₚ and/or a remote input device that comprises a key unit, or the like. Here, a touch panel that is provided to the display device of the display unit 350 may be used as the key unit that is provided to the main body portion. It should be understood that it would also be possible to employ a structure in which input is performed by audio using an audio recognition technique, instead of, or as well as, providing a key unit.

Settings for the details of operation of the navigation device 300Aₚ are made, and operation commands are inputted thereto, by the user actuating this operation input unit 360. For example, settings related to route searching for navigation processing that will be described hereinafter, such as the destination and so on, are made by the user utilizing the operation input unit 360. This sort of input data is sent from the operation input unit 360 to the control unit 310A as operation input data.

The traveling information acquisition unit 370 described above comprises an acceleration sensor, an angular velocity sensor, and so on, and detects the acceleration and the angular velocity during operation of the vehicle. Furthermore, this traveling information acquisition unit 370 acquires the result detected by the vehicle speed sensor 390ₚ as speed data, which is utilized in relation to data transfer between the navigation device 300Aₚ and a vehicle speed sensor 390ₚ that is mounted to the vehicle CRₚ. The data of various types acquired in this manner is sent to the control unit 310A as travelling data.

The GPS reception unit 375 described above calculates the current position of the vehicle CRₚ on the basis of the result of receiving radio waves from a plurality of GPS satellites. Moreover, this GPS reception unit 375 times the current time instant on the basis of the date and time information sent from the GPS satellites. This information related to this current position and current time instant is sent as GPS data to the control unit 310A.

The camera unit 380 described above comprises an onboard camera not shown in the figures and a data processing unit. The onboard camera may, for example, be disposed behind the driver's mirror. And this onboard camera photographs an image around the direction of progression of the vehicle and close to the normal line of sight of the driver as video. The data processing unit converts the results of photography by the onboard camera into digital image data. And the digital image data for the image around the vehicle photographed in this manner is sent to the control unit 310A as a photographic image.

Next, the control unit 310A described above will be explained. This control unit 310A comprises a central processing device (CPU) and circuitry peripheral thereto. Various types of the functions described above are implemented by the control unit 310A executing programs of various types. Among these functions, there are included functions which serve as the photographic state reporting means 723, the acquisition means 724, and the display control means 725 in the embodiment described above.

In response to a route searching command from the user in which a destination is specified and so on, this control unit 310A finds a planned travel route for the vehicle CRₚ to the destination by utilizing information for navigation that is stored in the storage device 320. Here, the route searching command from the user in which a destination is specified and so on is notified to the control unit 310A from the operation input unit 360 as operation input data. The planned travel route that has been found in this manner is sent to the server device 200A via the wireless communication unit 330.

Furthermore, the control unit 310A periodically acquires traveling data from the traveling information acquisition unit 370 and GPS data from the GPS reception unit 375. And, along with detecting the current position of the vehicle CRₚ, the control unit 310A also detects the current date and time upon the basis of timing results in the GPS data, and upon the result of reading an internal timer.

Moreover, via the wireless communication unit 330, the control unit 310A receives from the server device 200A requests for photography when passing through predetermined road junctions. And, upon receipt of such a request for photography, the control unit 310A generates a command for photography from the photography start ground point specified by that request for photography to the photography end ground point, and sends this command to the camera unit 380. Moreover, via the wireless communication unit 330, the control unit 310A acquires weather information when passing through road junctions.

And the control unit 310A acquires a photographic image from the camera unit 380, and also generates driving time information on the basis of the traveling data, the GPS data, and the weather information. Here, in this first example, speed change information for the vehicle CRₚ and the “season”, “time band” and “weather” environmental factor information are included in the driving time information. Next, the control unit 310A sends this photographic image and information related to the time of photography to the server device 200A, via the wireless communication unit 330.

Yet further, via the wireless communication unit 330, the control unit 310A sends to the server device 200A a request for acquisition of image information for predetermined road junctions upon the travel route planned based upon the result of route searching. And, in response to this acquisition request, the control unit 310A acquires from the server device 200A image information for the road junctions that correspond to the acquisition request.

Even further, the control unit 310A processes the image information acquired from the server device 200A, and generates display data corresponding to that image information and sends it to the display unit 350. During this processing, on the basis of the driving time information included in the image information, and of the traveling data, the control unit 310A controls the display unit 350 so that the image which it displays matches the manner in which the vehicle is passing through the road junctions.

### <Operation>

The operation of the road junction guidance system 100A having the structure as described above will now be explained, with attention principally being directed to the processing for generation of the standard image information.

### <<Processing for Generation of the Standard Image Information>>

First, the generation processing for the standard image information (SIA) in the storage device 210A of the server device 200A will be explained.

It should be understood that it will be anticipated that route searching is performed by the navigation device 300Aₚ, and that the planned travel route that is the result of this searching is reported to the server device 200A. And it will be anticipated that the server device 200A searches whether or not any predetermined road junction that should be registered in the storage device 210A is present upon this planned travel route, and, if such a predetermined road junction is indeed present upon this planned travel route, then it reports a request for photography thereof to the navigation device 300Aₚ that reported this planned travel route.

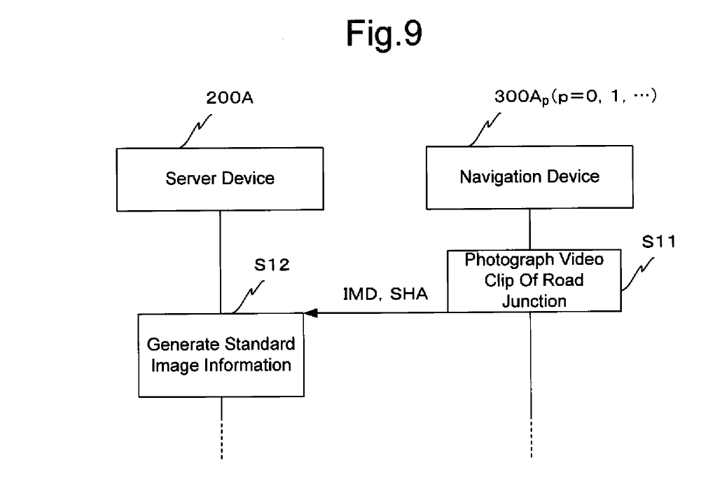

During the generation processing for this standard image information, first, as shown in FIG. 9, in a step S11, when passing through the predetermined road junction for which the request for photography has been received, the navigation device 300Aₚ photographs a video clip of that predetermined road junction, and also acquires information related to the time of photography thereof. When photography of that predetermined road junction has been completed, the navigation device 300Aₚ transmits the photographic image (IMD) and the information related to the timing of photography (SHA) to the server device 200A, at a predetermined timing.

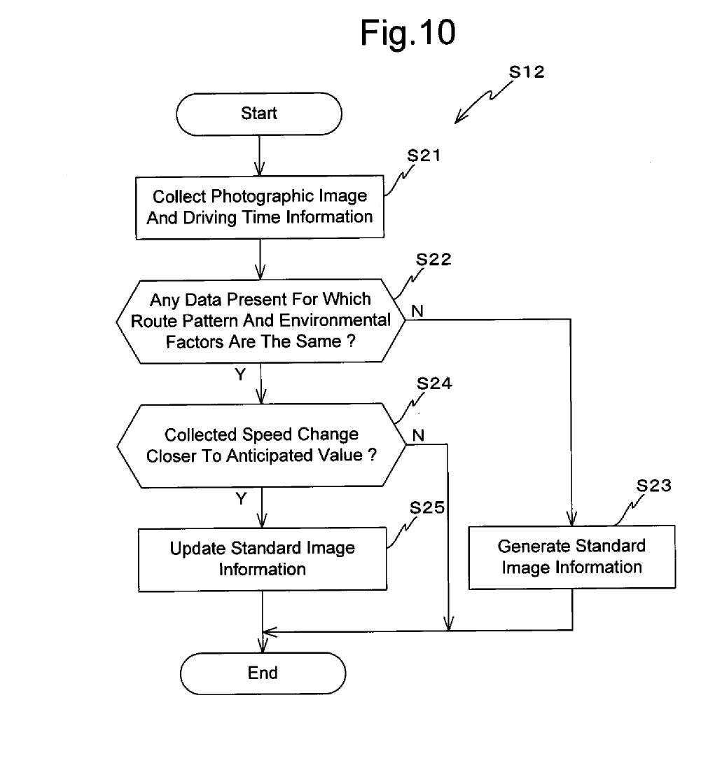

Upon receipt of this photographic image (IMD) and this information related to the time of photography (SHA), in a step S12, the server device 200A performs processing for generation of the standard image information. In this step S12, as shown in FIG. 10, first in a step S21, via the transmission and reception part 220, upon receipt from any one of the navigation devices 300Aₚ (where p=1, 2, . . . ) of a photographic image and information related to the time of photography thereof, the processing control part 230A collects that photographic image and information related to the time of photography.

Next, in a step S22, the processing control part 230A accesses the storage device 210A, and makes a judgment as to whether or not, among the individual standard image information for the predetermined road junction corresponding to the photographic image that has been collected, there exists any photographic image for which the route pattern is the same, and moreover for which the various environmental factors of “season”, “time”, and “weather” are the same. If the result of this judgment is negative (N in the step S22), then the flow of control proceeds to a step S23.

In this step S23, the processing control part 230A generates individual standard image information on the basis of this photographic image and the information related to the time of photography, and registers it in the storage device 210A. When this registration has been completed, this generation processing for the standard image information of the step S12 terminates.

On the other hand, if the result of the judgment in the step S22 is affirmative (Y in the step S22), then the flow of control is transferred to a step S24. In this step S24, the processing control part 230A compares together the speed change information that has been collected and the speed change information during acquisition of the photographic image that is registered in the individual standard image information, and makes a judgment as to whether or not it is the speed change information that has been collected that is closer to the speed variation condition. If the result of this judgment is negative (N in the step S24), then this generation processing for the standard image information of the step S12 terminates.

On the other hand, if the result of the judgment in the step S24 is affirmative (Y in the step S24), then the flow of control is transferred to a step S25. In this step S25, the processing control part 230A updates the individual standard image information on the basis of this photographic image and the information related to the time of photography, and registers it in the storage device 210A. And, when this registration has been completed, this generation processing for the standard image information of the step S12 terminates.

### <<Road Junction Guidance Processing>>

Next, the road junction guidance processing by this road junction guidance system 100A will be explained.

When, in the navigation device 300Aₚ, a route searching command in which a destination and so on has been designated is inputted by the user to the operation input unit 360, then route searching is performed by the control unit 310A, and a planned travel route is derived. This planned travel route is transmitted to the server device 200A via the wireless communication unit 330. Furthermore, along with this planned travel route, it is arranged for acquisition requests for image information for the predetermined road junctions that are present along this planned travel route to be automatically transmitted to the server device 200A

When the processing control part 230A in the server device 200A receives the planned travel route and a request for acquisition of image information from the navigation device 300Aₚ, it accesses the storage device 210A and performs searching for whether or not this predetermined road junction upon that travel route is present. If this predetermined road junction upon that travel route is present, then the processing control part 230A reads out from the storage device 210A the image information for when that predetermined road junction corresponding to that acquisition request was passed through. Next, the processing control part 230A transmits this image information to the navigation device 300Aₚ that issued the acquisition request, via the transmission and reception part 220.

In the navigation device 300Aₚ that issued the acquisition request, the control unit 310a acquires from the server device 200A the image information for when the desired road junction was passed through. While the vehicle CRₚ passes through that road junction, the control unit 310A displays the above photographic image upon the display unit 350, while referring to the way in which the vehicle CRₚ is passing through the road junction.

As has been explained above, in this first example, when the server device 200A collects a photographic image and information related to the time of photography from the navigation device 300Aₚ that is receiving a request for photography, the processing control part 230A of the server device 200A starts generation processing for standard image information. During this generation of the standard image information, the processing control part 230A decides whether or not any photographic image already exists of this predetermined road junction, for which the route pattern is the same and moreover the various environmental factors are the same. If no such photographic image exists, then the processing control part 230A generates standard image information on the basis of the photographic image and the information related to the time of photography. On the other hand, if such a photographic image does exist, then the processing control part 230A updates the contents of the individual standard image information if the photographic image that has been newly collected matches the speed variation condition more closely.

Furthermore, when image information in which a desired road junction is designated is acquired by the navigation device 300Aₚ from the server device 200A, then, while making reference to the way in which the vehicle CRₚ is passing through that road junction, the control unit 310A of that navigation device 300Aₚ displays an image based upon that image information upon its display unit 350, matched to the passage of the vehicle CRₚ through that road junction.

Thus, according to this first example, along with utilizing storage resources with good efficiency, it is also possible to enhance the convenience for the user.

### The Second Example

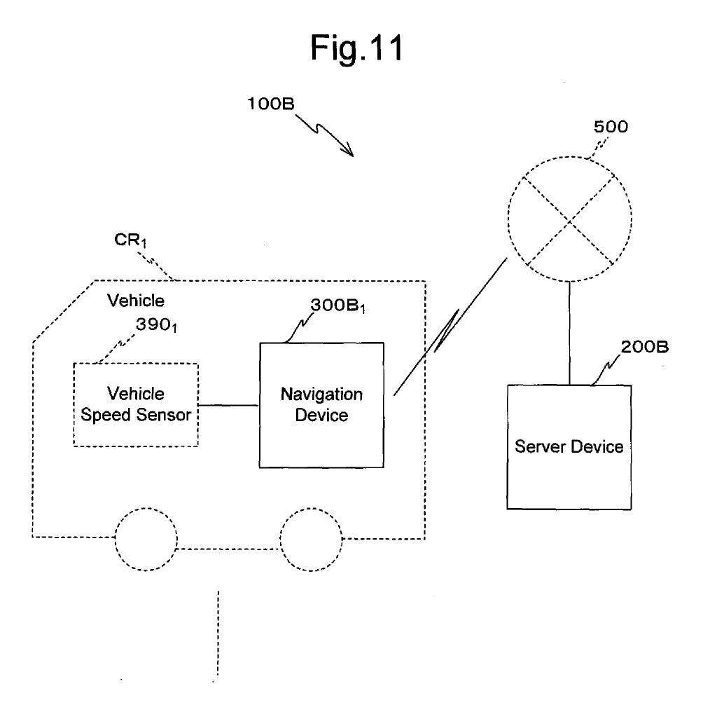

Next, the second example of the present invention will be explained with principal reference to FIGS. 11 through 18.

In FIG. 11, there is shown the schematic structure of a road junction guidance system 100B according to this second example. It should be understood that, similarly to the case with the road junction guidance system 100A according to the first example, this road junction guidance system 100B is one aspect of the road junction guidance system 700 of the embodiment described above.

### <Structure>

As shown in FIG. 11, this road junction guidance system 100B comprises a server device 200B that plays the role of the server device 710, and navigation devices 300Bₚ that play the roles of the mobile terminals 720ₚ (where p=1, 2, . . . ). In other words, as compared with the road junction guidance system 100A of the first example described above, this road junction guidance system 100B comprises the server device 200B instead of the server device 100A, and comprises the navigation devices 300Bₚ instead of the navigation devices 300Aₚ. In the following explanation, attention will be principally directed to these points of difference.

### <<Structure of the Server Device 200B>>

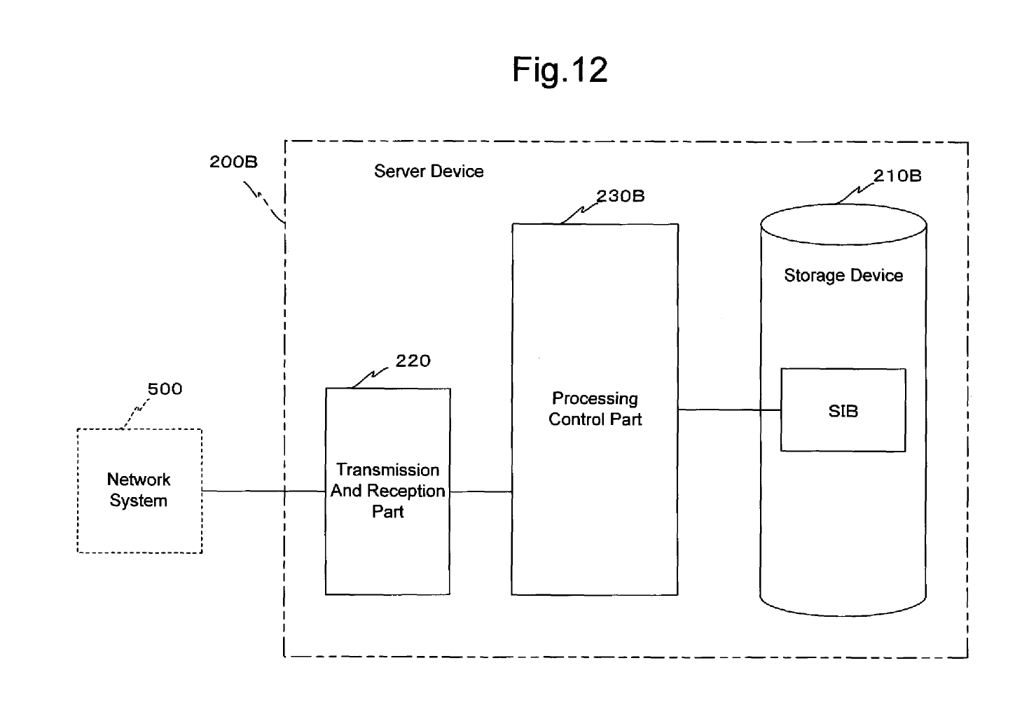

As shown in FIG. 12, as compared with the server device 200A described above, the server device 200B mentioned above differs by the feature that it comprises a storage device 210B instead of the storage device 210A, and by the feature that it comprises a processing control part 230B instead of the processing control part 230A.

In a similar manner to the storage device 210A described above, the storage device 210B mentioned above consists of a non-volatile storage device such as a hard disk device or the like. As compared with the storage device 210A, this storage device 210B differs by the feature that it stores standard image information (SIB) instead of the standard image information (SIA).

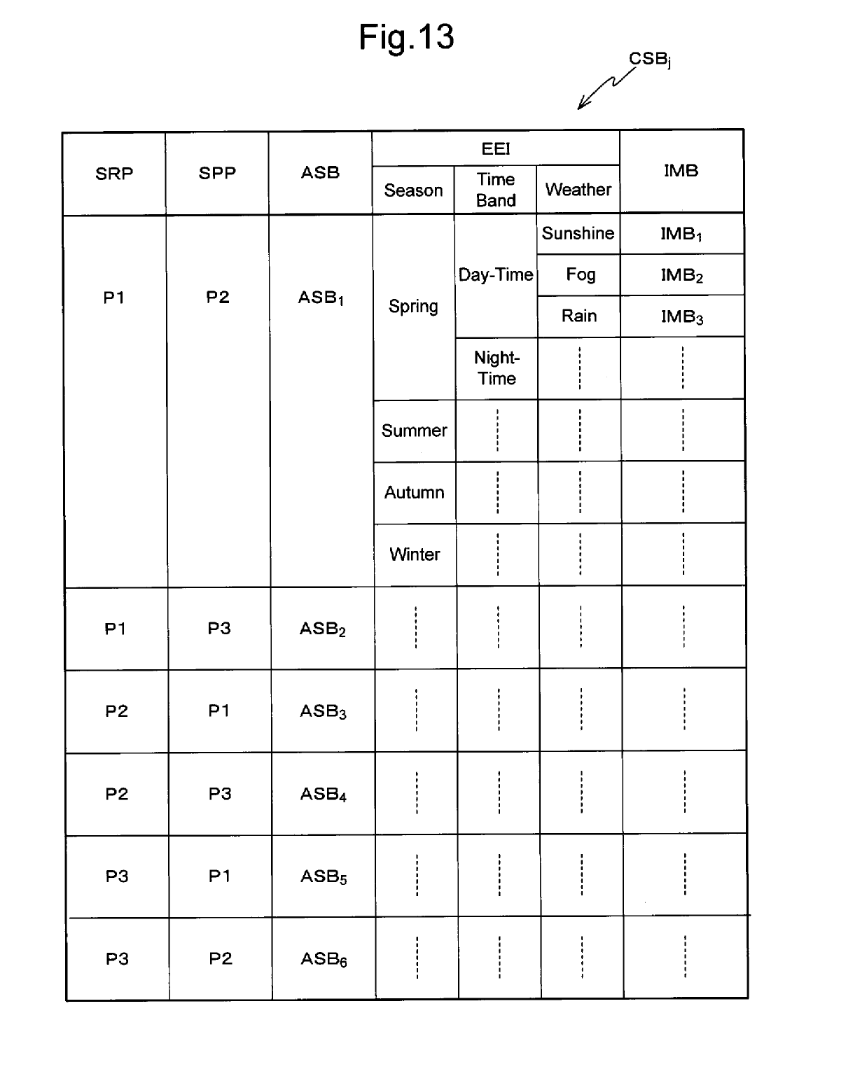

Individual standard image information CSBⱼ (where j=1, 2, . . . ) for each of the predetermined road junctions, having contents as shown in FIG. 13, is registered in this standard image information (SIB) mentioned above. This individual standard image information CSBⱼ includes, for each route pattern at the predetermined road junction, the individual standard image information CSBⱼ contains a photography start ground point (SRP), a photography end ground point (SPP), a positional condition (ASB), and photographic image information (IMB) classified by information about environmental factors at the time of photography (EEI); and, as compared to the individual standard image information CSAⱼ described above, this individual standard image information CSBⱼ differs by the features that it includes a positional condition instead of speed variation conditions, and that the contents of the photographic image information are different.

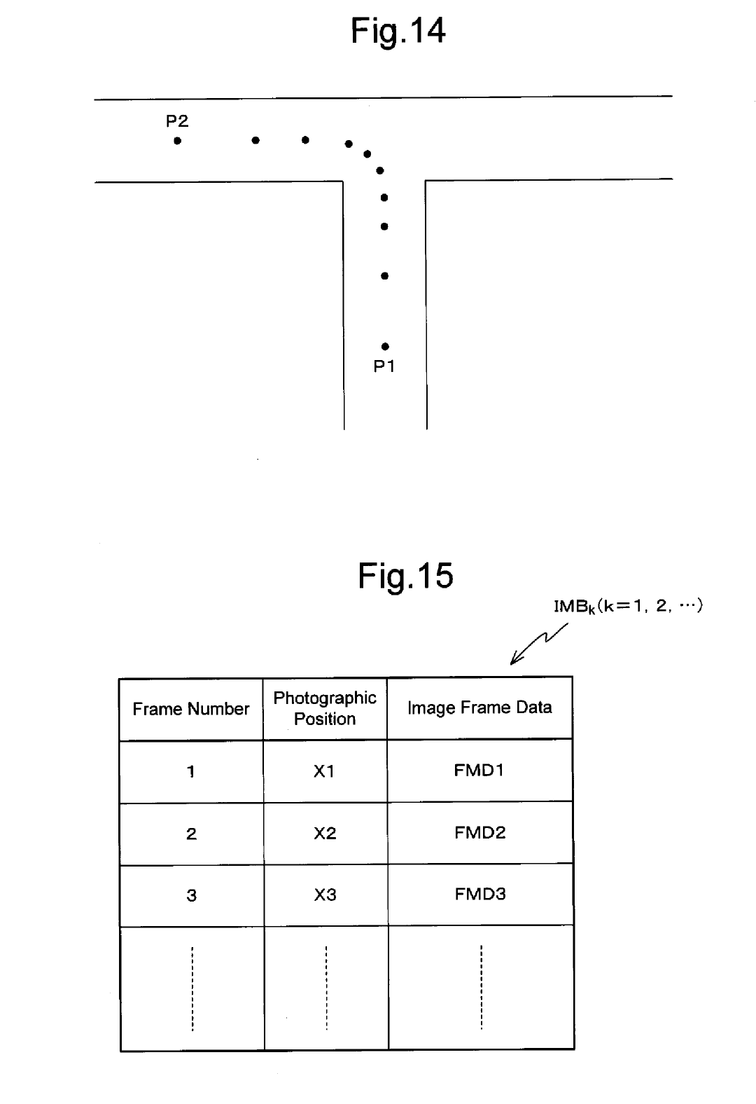

The positional condition (ASB) is derived from the speed variation condition described above. In this second example, this positional condition (ASB) is a condition related to the photographic positions of the image frames, and is that the positions at predetermined time intervals while the vehicle CRₚ passes through the predetermined road junction while satisfying the speed variation condition are approximately the same. In FIG. 14, as an example of such a positional condition, there are shown the photographic positions of the image frames while the vehicle CRₚ travels from P1 towards P2 and executes a left turn at that road junction. The gaps between the photographic positions get narrower, because the vehicle decelerates while making a left turn in this manner.

It should be understood that the positional condition described above is determined in advance by experiment, simulation, experience, or the like.

Furthermore, in this second example, as shown in FIG. 15, for each frame, image frame data is recorded in the photographic image information (IMB) in correspondence with its position of photography.

Returning to FIG. 12, in a similar manner to the processing control part 230A described above, the processing control part 230B mentioned above comprises a central processing device (CPU) and circuitry peripheral thereto, and is adapted to execute programs of various kinds. As compared to the processing control part 230A described above, in this processing control part 230B, the function of the generation means 713 is different.

When, upon receipt of a request for photography, via the transmission and reception part 220, this processing control part 230B collects a photographic image and information related to the time of photography thereof from the navigation device 300Bₚ, then it generates standard image information photographed when the vehicle CRₚ passed through the predetermined road junction in a manner that satisfies the positional condition. It should be understood that, in this second example, as will be described hereinafter, photographic position information corresponding to the image frame and the environmental factor information for “season”, “time band” and “weather” are included in this information related to the time of photography.

While generating this standard image information, the processing control part 230B decides, for each image frame of the photographic image that has been collected, whether or not the photographic position of that image frame satisfies the positional condition. Next, if the photographic position of that image frame satisfies the positional condition, then the processing control part 230B accesses the storage device 210B, and decides whether or not, among the individual standard image information for the predetermined road junction corresponding to the photographic image that has been collected, there exists, in some photographic image for which the route pattern is the same, and moreover for which the environmental factors of “season”, “time”, and “weather” are the same, some image frame for which the photographic position is the same. And, if no such image frame for which the photographic position is the same exists, then the processing control part 230B employs the image frame of the photographic image that has been collected as a part of the individual standard image information.

On the other hand, if such an image frame for which the photographic position is the same does exist, then a decision is made as to whether or not a continuous smooth image will result, if this image frame of the photographic image that has been collected is employed as individual standard image information. And, if it is decided that the result will be smooth, then this image frame of the photographic image that has been collected is employed as individual standard image information; but, if it is decided that the result will not be smooth, then this image frame of the photographic image that has been collected is not employed as individual standard image information.

Here, by a “continuous smooth image” is meant an image for which, when an image frame of the photographic image that has been collected is employed as standard image information, then, when compared to the previous and subsequent image frames that are stored in the storage device 210B, the movement of elements in the entire frame does not greatly change (for example, deviation of their positions in the image, or a sudden motion occurring, or the like).

### <<Structure of the Navigation Devices 300Bₚ>>

As compared to the navigation devices 300Aₚ described above, the abovementioned navigation devices 300Bₚ have similar structures, with the exception of the feature that the function of the photographic information reporting means 723 in the control unit is different. Due to this, in the following explanation, it will be supposed that the control unit in the navigation device 300Bₚ is termed the “control unit 310B”.

The control unit 310B described above acquires a photographic image from the camera unit 380, and also generates driving time information on the basis of the traveling data, the GPS data, and the weather information. Here, in this second example, photographic position information in correspondence with the image frames, and also the environmental factor information of “season”, “time band”, and “weather”, are included in the driving time information. And the control unit 310B sends this photographic image and this information related to the time of photography to the server device 200B via the wireless communication unit 330.

### <Operation>

The operation of this road junction guidance system 100B having the structure described above will now be explained with principal emphasis being given to the process of generating the standard image information.

### <<Generation Processing for the Standard Image Information>>

First, the processing for generating the standard image information (SIB) in the storage device 210B of the server device 200B will be explained.

It should be understood that it will be supposed that, in a similar manner to the case with the first example, route searching is performed by the navigation device 300Bₚ, and the planned travel route that is the result of this searching is reported to the server device 200B. And it will be supposed that a search is made by the server device 200B for whether any predetermined road junction that should be registered in the storage device 210B is present upon this planned travel route, and, if such a predetermined road junction is indeed present upon that planned travel route, then a request for photography is reported to the navigation device 300Bₚ that reported that planned travel route.

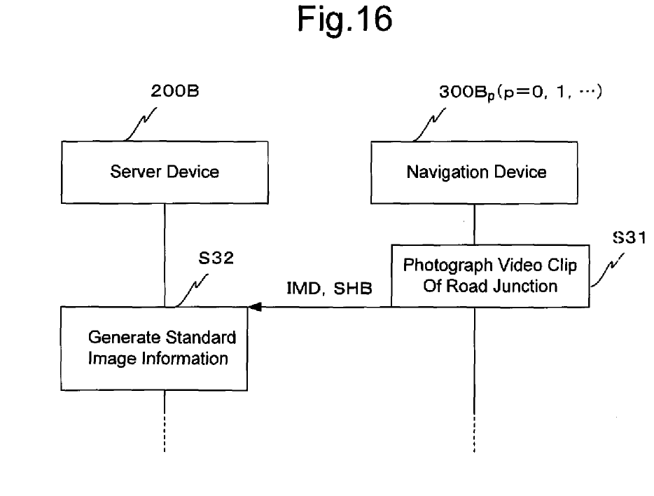

During the above generation processing for the standard image information, as shown in FIG. 16, in a step S31, while passing through the predetermined road junction for which the request for photography was received, the navigation device 300Bₚ photographs a video clip of that predetermined road junction, and also acquires information related to the time of photography. And, when this photography of the predetermined road junction has been completed, the navigation device 300Bₚ transmits the photographic image (IMD) and the information related to the time of photography (SHB) to the server device 200B, at a predetermined timing.

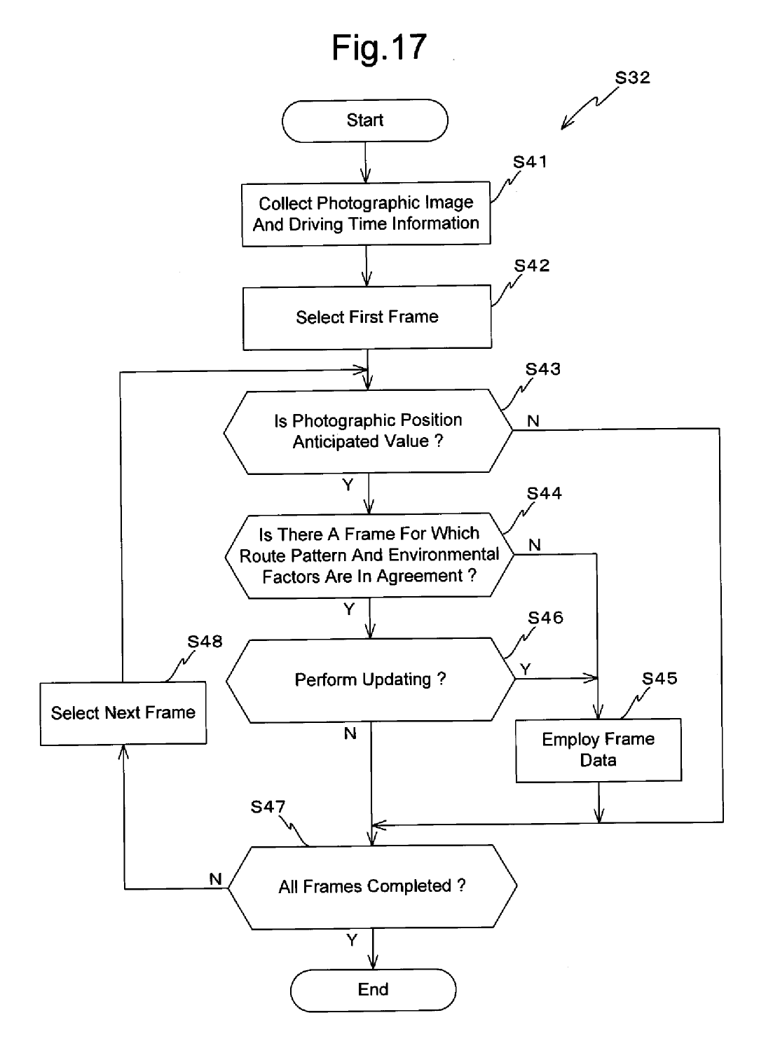

Upon receipt of this photographic image (IMD) and information related to the time of photography (SHB), in a step S32, the server device 200B performs generation processing for the standard image information. In this step S32, as shown in FIG. 17, first in a step S41, when a photographic image and information related to the time of photography are received from any one of the navigation devices 300Bₚ (where p=1, 2, . . . ), the processing control part 230B collects, via the transmission and reception part 220, that photographic image and information related to the time of photography.

Next, in a step S42, the processing control part 230B selects the first frame of the photographic image that has been collected. Then the flow of control proceeds to a step S43.

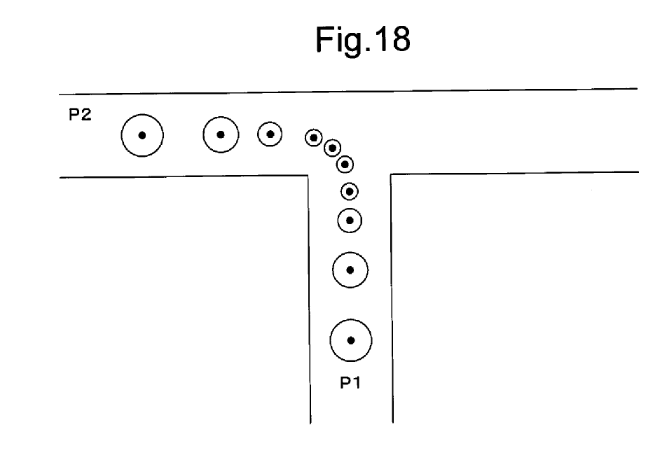

In this step S43, the processing control part 230B makes a judgment as to whether or not the photographic position of this frame satisfies the positional condition. Here, as shown in FIG. 18, whether or not the photographic position satisfies the positional condition is decided according to whether or not the photographic position is within a permitted range. This permitted range depends upon the speed of the vehicle CR, and is wider the faster the speed of the vehicle CR is, and is narrower the slower that speed is. If the result of the judgment in the step S43 is negative (N in the step S43), then the flow of control is transferred to a step S47 that will be described hereinafter.

On the other hand, if the result of the judgment in the step S43 is affirmative (Y in the step S43), then the flow of control proceeds to a step S44.

In this step S44, the processing control part 230B makes a judgment as to whether or not any image frame exists for which the route pattern and the environmental factors are the same. If the result of this judgment is negative (N in the step S44), then the flow of control proceeds to a step S45.

In this step S45, the processing control part 230B uses the image frame whose photographic image was collected as a portion of the individual standard image information. Subsequently, the flow of control proceeds to the step S47.

On the other hand, if the result of the judgment in the step S44 is affirmative (Y in the step S44), then the flow of control is transferred to a step S46.

In this step S46, the processing control part 230B makes a judgment as to whether or not to perform updating of the standard image information by making the image frame of the photographic image that has been collected a portion of the individual standard image information. Here, whether or not to perform updating of the individual standard image information is decided as to whether or not, if the image frame of the photographic image that has been collected is employed as the individual standard image information, then this will result in a continuous smooth image. If the result of this judgment is affirmative (Y in the step S46), then the flow of control returns to the step S45.

On the other hand, if the result of the judgment in the step S46 is negative (N in the step S46), then the flow of control proceeds to the step S47.

In this step S47, the processing control part 230B makes a judgment as to whether or not the processing of the steps S43 through S46 described above has been performed for all of the image frames. If the result of this judgment is negative (N in the step S47), then the flow of control proceeds to a step S48.

In this step S48, the processing control part 230B selects the next image frame. And, after having selected the next image frame in this manner, the processing control part 230B again performs the processing of the steps S43 through S46.

On the other hand, if the processing of the steps S43 through S46 has been performed for all of the image frames, and the result of the judgment in the step S47 becomes affirmative (Y in the step S47), then the processing of this step S32 for generating the standard image information terminates.

### <<Road Junction Guidance Processing>>

The road junction guidance processing by this road junction guidance system 100B is performed in a similar manner to the road junction guidance processing by the road junction guidance system 100A of the first example described above.

As has been explained above, in this second example, when the server device 200B collects a photographic image and information related to the time of photography from the navigation device 300Bₚ that receives a request for photography, then the processing control part 230B of the server device 200B starts the processing for generation of the standard image information. During this generation of the standard image information, for each image frame in the photographic image that has been collected, the processing control part 230B extracts the photographic position that corresponds to that image frame, and decides whether or not the positional condition that is derived from the speed variation condition is satisfied. And, when the photographic position of the photographic image that has been newly collected does satisfy that condition, then this image frame of the photographic image that has been collected is utilized for updating the standard image information.

Moreover, when desired road junction is specified by the navigation device 300Bₚ and image information is acquired from the server device 200B, then the control unit 310B of the navigation device 300Bₚ displays an image based upon that image information upon the display unit 350 while referring to the way in which the vehicle CRₚ is passing through the road junction, and thus matched to the passage of the vehicle CRₚ through that road junction.

Thus, according to this second example, in a similar manner to the first example described above, along with the storage resources being employed with good efficiency, also it is possible to enhance the convenience from the point of view of the user.

### Modification of the Example

The present invention is not to be considered as being limited to the examples described above: variations of many types may be made.

For example, in the first and second examples described above, it was arranged for the navigation device, to have not only the function of transmitting the photographic image that was photographed and the information related to the time of photography that was acquired to the server device, but also the function of acquiring the image information for the desired road junction from the server device. By contrast, if it is supposed that a navigation device having the functions described above is present among the navigation devices in the road guidance system, then it would also be acceptable for some of those navigation devices not to have the functions of acquiring and transmitting to the server device photographic images and information related to the time of photography thereof, although they do have the function of acquiring image information for desired road junctions from the server device.

And while, in the first and second examples described above, a structure is shown in which the navigation devices are mounted to the vehicles CRₚ, it would also be possible to employ a construction in which, in the navigation device, the function of the control unit is separated from the main body portion of the navigation device, and is provided by a transportable device that, along with being capable of being installed to said main body portion, can also be installed to a personal computer that is provided in, for example, a household. In this case, it would be acceptable to arrange for the transportable device to transmit the photographic image and the information related to the time of photography thereof that have been acquired to the server device, via the personal computer. Moreover, it would also be acceptable to arrange for the transportable device to receive a request for photography from the server device, via the personal computer.

Moreover while, in the first and second examples described above, it was arranged for the navigation device to search for the planned travel route for the vehicle to the destination, it would also be acceptable for it to be the server device that performs this searching for the planned travel route. In this case, the server device would transmit this planned travel route to the navigation device.

Furthermore while, in the first and second examples described above, the information about environmental factors at the time of photography was supposed to be “season”, “time band”, and “weather”, the combination of environmental factor information could be any desired combination, and it would also be acceptable for it to include other environmental factors. Yet further, the classification of environmental factors could be performed in any desired manner: for example, “weather” could be classified into “sunshine”, “fog, “rain”, and “snow”.

And yet further, in the first and second examples described above, it was arranged for the server device, when a planned travel route is reported from some navigation device, to send a request for photography when passing through a desired road junction upon that planned travel route to the navigation device that reported that travel route. By contrast, if the normal range of travel of the vehicle is known, it would be also be possible to arrange for the server device to send a request for photography when passing through a desired road junction within this range of travel. Moreover it would also be possible, if positional information for the vehicles is periodically being received from the navigation devices, to arrange to send a request for photography when passing through a desired road junction among the road junctions that it is estimated, from the variation of this positional information, that a vehicle will pass through, to that navigation device for which it is estimated that it will pass through that road junction.

Even further while, in the first and second examples described above, it was arranged for the control unit to control the display unit and to display an image on the basis of image information for the desired road junction, it would also be acceptable to arrange for the control unit to display this image as accentuated by performing highlighting processing or the like upon it. Still further it would also be acceptable, during route guidance through the desired road junction, to arrange for the control unit to perform overlay display of an arrow sign upon the image; and yet further, it would be acceptable to arrange to use audio output from an audio output unit together with this display.

Furthermore while, in the first and second examples described above, it was arranged to implement the functions of various means, with the exception of the functions of the storage means, the photographic means and the display means, by a computer executing a program, it would also be acceptable to arrange to implement all or a portion of these various means in hardware, using one or more dedicated LSIs (Large Scale Integrated circuits) or the like.

1-13. (canceled)

14. A server device that can communicate with at least one mobile terminal comprising:
a collection part configures to collect a photographic image and information related to the time of photography thereof, reported from a mobile terminal that receives a request for photography when passing through at least one predetermined road junction;
a generation part configures to, on the basis of the results of collection by said collection part, generate standard image information photographed while passing through said predetermined road junction with a predetermined speed variation condition being satisfied;
a storage part configures to store said standard image information; and
a standard image reporting part configures to, upon receipt of an acquisition request for an image for a passage through one of said predetermined road junction, report image information corresponding, in said standard image information, to said acquisition request, to the mobile terminal that issued said acquisition request.

15. A server device according to claim 14, wherein said collection part issues said request for photography in which a photography start ground point and a photography end ground point are specified.

16. A server device according to claim 14, wherein:
information about at least one environmental factor at the time of photography, such as the date and time of photography and the weather at the time of photography, is included in said information related to the time of photography;
said standard image information is stored in said storage part, classified by said environmental factor; and
a designation of said environmental factor is included in said acquisition request.

17. A server device according to claim 14, characterized in that:
speed change information while the moving body that is moving along with the mobile terminal that receives said request for photography passes through said predetermined road junction, is included in said information related to the time of photography; and
said generation part configures to generate said standard image information, if said speed change information satisfies said predetermined speed variation condition.

18. A server device according to claim 14, wherein:
photographic position information for each image frame of said photographic image is included in said information related to the time of photography; and
said generation part employs, during the generation of said standard image information, an image frame of said photographic image for which said photographic position information satisfies a positional condition that is derived from said predetermined speed variation condition.

19. A mobile terminal that moves along with a moving body and that can communicate with a server device according to claim 14, wherein:
a display part configures to displays an image;
an acquisition part configures to makes an acquisition request to said server device, and acquires from said server device image information when passing through a road junction, corresponding to said acquisition request; and
a display control part configures to perform control of display upon said display part of an image based upon the result of acquisition by said acquisition part.

20. A mobile terminal according to claim 19, wherein said display control part controls display upon said display part of said image based upon said result of acquisition, while referring to the way in which said moving body passes through said road junction.

21. A mobile terminal according to claim 19, further comprising:
a photographic part configures to photographs the surroundings of said moving body;
a driving time information acquisition part configures to acquires driving time information for said moving body; and
a photographic information reporting part configures to reports to said server device the result of photography by said photographic part when passing through at least one predetermined road junction for which a request for photography has been received, and information related to the time of photography when passing through said at least one predetermined road junction, generated on the basis of the result of acquisition by said driving time information acquisition part.

22. A mobile terminal according to claim 21, wherein at least one of the current positions of said moving body and the speed of said moving body is included in said driving time information.

23. A mobile terminal according to claim 22, wherein at least one environmental factor, of the date and time and the weather, is further included in said driving time information.

24. A road junction guidance system, comprising a server device according to claim 14; and at least one mobile terminal that can communicate with said server device, and in that said mobile terminal comprises:
a display part configures to display an image;
an acquisition part configures to make an acquisition request to said server device, and acquires from said server device image information when passing through a road junction, corresponding to said acquisition request; and
a display control part configures to perform control of display upon said display part of an image based upon the result of acquisition by said acquisition part.

25. A road junction guidance system according to claim 24, wherein said mobile terminal further comprises:
a photographic part configures to photographs the surroundings of said moving body;
a driving time information acquisition part configures to acquire driving time information for said moving body; and
a photographic information reporting part configures to reports to said server device the result of photography by said photographic part when passing through at least one predetermined road junction for which a request for photography has been received, and information related to the time of photography when passing through said at least one predetermined road junction, generated on the basis of the result of acquisition by said driving time information acquisition part.

26. A road junction guidance method performed in cooperation by at least one mobile terminal and a server device that can communicate with said mobile terminal comprising the steps of:
collecting a photographic image and information in which said server device collects a photographic image and information related to the time of photography thereof, reported from a mobile terminal that receives a request for photography when passing through at least one predetermined road junction;
generating standard image information in which, on the basis of the results of collection by said collection process, said server device generates standard image information photographed while passing through said predetermined road junction with a predetermined speed variation condition being satisfied;
reporting a standard image in which said server device, upon receipt of an acquisition request for an image for a passage through one of said predetermined road junction, reports an image corresponding, in said standard image information, to said acquisition request, to the mobile terminal that issued said acquisition request; and
performing a display in which the mobile terminal that issued said acquisition request performs display on the basis of image information that corresponds to said acquisition request.

27. A server device according to claim 15, characterized in that:
speed change information while the moving body that is moving along with the mobile terminal that receives said request for photography passes through said predetermined road junction, is included in said information related to the time of photography; and
said generation part configures to generate said standard image information, if said speed change information satisfies said predetermined speed variation condition.

28. A server device according to claim 16, characterized in that:
speed change information while the moving body that is moving along with the mobile terminal that receives said request for photography passes through said predetermined road junction, is included in said information related to the time of photography; and
said generation part configures to generate said standard image information, if said speed change information satisfies said predetermined speed variation condition.

29. A server device according to claim 15, wherein:
photographic position information for each image frame of said photographic image is included in said information related to the time of photography; and
said generation part employs, during the generation of said standard image information, an image frame of said photographic image for which said photographic position information satisfies a positional condition that is derived from said predetermined speed variation condition.

30. A server device according to claim 16, wherein:
photographic position information for each image frame of said photographic image is included in said information related to the time of photography; and
said generation part employs, during the generation of said standard image information, an image frame of said photographic image for which said photographic position information satisfies a positional condition that is derived from said predetermined speed variation condition.

31. A mobile terminal that moves along with a moving body and that can communicate with a server device according to claim 15, wherein:
a display part configures to displays an image;
an acquisition part configures to makes an acquisition request to said server device, and acquires from said server device image information when passing through a road junction, corresponding to said acquisition request; and
a display control part configures to perform control of display upon said display part of an image based upon the result of acquisition by said acquisition part.

32. A mobile terminal that moves along with a moving body and that can communicate with a server device according to claim 16, wherein:
a display part configures to displays an image;
an acquisition part configures to makes an acquisition request to said server device, and acquires from said server device image information when passing through a road junction, corresponding to said acquisition request; and
a display control part configures to perform control of display upon said display part of an image based upon the result of acquisition by said acquisition part.

33. A mobile terminal that moves along with a moving body and that can communicate with a server device according to claim 17, wherein:
a display part configures to displays an image;
an acquisition part configures to makes an acquisition request to said server device, and acquires from said server device image information when passing through a road junction, corresponding to said acquisition request; and
a display control part configures to perform control of display upon said display part of an image based upon the result of acquisition by said acquisition part.
